(19) United States
(12) Patent Application Publication
(10) Pub. No.: US 2016/0014103 A1
(43) Pub. Date: Jan. 14, 2016

(54) PHYSICAL ACCESS CONTROL AUTHENTICATION

(71) Applicant: Schweitzer Engineering Laboratories, Inc., Pullman, WA (US)

(72) Inventors: George W. Masters, Moscow, ID (US); Rhett Smith, Kuna, ID (US)

(21) Appl. No.: 14/328,557

(22) Filed: Jul. 10, 2014

(51) Int. Cl. H04L 29/06; G07C 9/00

(52) U.S. Cl. CPC H04L 63/08; H04L 63/102; G07C 9/00007

(57) ABSTRACT

Disclosed herein are a variety of systems and methods for authentication physical access to a distributed site of an electric power generation and delivery system. According to various embodiments, a mobile device may be utilized as an input device for a physical access control system associated with a distributed site. Authentication credentials entered by a user using the mobile device may be communicated to the physical access control system for use in connection with authentication and/or access control decisions. Using the mobile device may, among other things, allow for users to provide certain authentication credentials to the physical access control system without the need to utilize certain input devices that may be prone to damage and/or failure due to exposure to environmental conditions.

### TECHNICAL FIELD

This disclosure relates to systems and methods for physical access control authentication and, more particularly, to systems and methods for authenticating physical access to a distribution site of an electric power delivery system.

### BRIEF DESCRIPTION OF THE DRAWINGS

Non-limiting and non-exhaustive embodiments of the disclosure are described, including various embodiments of the disclosure, with reference to the figures, in which:

FIG. 1 illustrates an exemplary physical access control authentication architecture consistent with embodiments disclosed herein.

FIG. 2 illustrates a diagram showing an access control authentication process consistent with embodiments disclosed herein.

FIG. 3 illustrates a flow chart of a method for authenticating physical access consistent with embodiments disclosed herein.

FIG. 4 illustrates a functional block diagram of a physical access control system consistent with embodiments disclosed herein.

### DETAILED DESCRIPTION

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Electrical power generation and delivery systems are designed to generate, transmit, and distribute electrical energy to loads. Electrical power generation and delivery systems may include a variety of equipment, such as electrical generators, electrical motors, power transformers, power transmission and distribution lines, circuit breakers, switches, buses, transmission and/or feeder lines, voltage regulators, capacitor banks, and/or the like. Such equipment may be monitored, controlled, automated, and/or protected using intelligent electronic devices (“IEDs”) that receive electric power system information from the equipment, make decisions based on the information, and provide monitoring, control, protection, and/or automation outputs to the equipment.

In some embodiments, an IED may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communication processors, computing platforms, programmable logic controllers (PLCs), programmable automation controllers, input and output modules, governors, exciters, statcom controllers, SVC controllers, OLTC controllers, and the like. Further, in some embodiments, IEDs may be communicatively connected via a network that includes, for example, multiplexers, routers, hubs, gateways, firewalls, and/or switches to facilitate communications on the networks, each of which may also function as an IED. Networking and communication devices may also be integrated into an IED and/or be in communication with an IED. As used herein, an IED may include a single discrete IED or a system of multiple IEDs operating together.

Certain equipment associated with an electrical power generation and delivery system may be distributed in one or more sites and/or locations. For example, a variety of equipment (e.g., IEDs, network equipment, and/or the like) may be associated with a distribution substation location of an electric power delivery system. In some circumstances, distributed sites of an electrical power generation and delivery system may be located in relatively remote and/or infrequently accessed locations. For example, certain distributed sites may be accessed infrequently by individuals performing maintenance, diagnostic, and/or repair activities on equipment associated with the sites (e.g., utility and/or other service personnel).

To ensure the physical security of a distributed site and/or associated equipment, a distributed site may include one or more access control devices including, for example, locks (e.g., electromagnetic, mechanical, and/or solenoid locks), tamper protection devices, security-hardened buildings, enclosures, and/or utility boxes, alarm systems, and/or the like. A physical access control system in communication with the one or more access control devices may be configured to allow personnel wishing to access the distributed site to authenticate their identity and/or their rights to access the distributed site and/or associated equipment. Based on a successful authentication, the physical access control system may issue one or more control signals to associated access control devices configured to allow the personnel physical access to the distributed site and/or associated equipment (e.g., by issuing a control signal configured to disengage a solenoid lock, an alarm system, and/or the like).

Physical access control systems associated with a distributed site and/or equipment associated with the same may be exposed to environmental conditions (e.g., moisture, temperature fluctuations, wind, debris, etc.) that potentially contribute to degradation and/or failure of the access control system over time. In certain circumstances, damage to an input device of an access control system used by personnel to provide authentication credentials such as a key pad, a touchscreen, a card reader, a biometric sensor, etc. may render the access control system unable to properly perform authentication operations. For example, freezing conditions and/or wind-blown debris may cause increased mechanical wear and associated failure in a 10-digit key pad associated with an access control system. Similarly, environmental wear may reduce the accuracy and/or otherwise damage biometric sensors of an access control system. Ensuring access control system reliability in a variety of environmental conditions may involve expensive environmental hardening during installation as well as on-going maintenance and repair costs.

Consistent with embodiments of the systems and methods disclosed herein, a mobile computing device such as, for example, a smartphone, may be used as an input device in connection with a physical access control system associated with a distributed site of electrical power generation and delivery system. In certain embodiments, utilizing a mobile device as an input device for a physical access control system may, among other things, allow for service and other personnel to provide authentication credentials to the physical access control system without the need to utilize a static and/or otherwise integrated input device associated with the access control system (e.g., input devices that may be prone to damage and/or failure due to exposure to environmental conditions). In some embodiments, the mobile device may be configured to communicate with the physical access control system using a wireless communication protocol. In further embodiments, the mobile device may be configured to communicate with the physical access control system using a wired communication protocol (e.g., via an environmentally-hardened communication port or the like).

In certain embodiments, the mobile device may be provisioned with an application allowing personnel wishing to access a distributed site to input authentication credentials using the mobile device. The mobile device may communicate the authentication credentials to the physical access control system of the distributed site. The physical access control system may authenticate, based at least in part on the authentication credentials, whether the personnel requesting access to the distributed site has rights to access the site. Based on a successful authentication, the physical access control system may issue one or more control signals to associated access control devices configured to allow the personnel physical access to the distributed site and/or associated equipment.

Several aspects of the embodiments described herein are illustrated as software modules or components. As used herein, a software module or component may include any type of computer instruction or computer executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions. In some embodiments, the computer or other electronic device may include a processing device such as a microprocessor, microcontroller, logic circuitry, or the like. The processing device may further include one or more special purpose processing devices such as an application specific interface circuit (“ASIC”), PAL, PLA, PLD, field programmable gate array (“FPGA”), or any other customizable or programmable device.

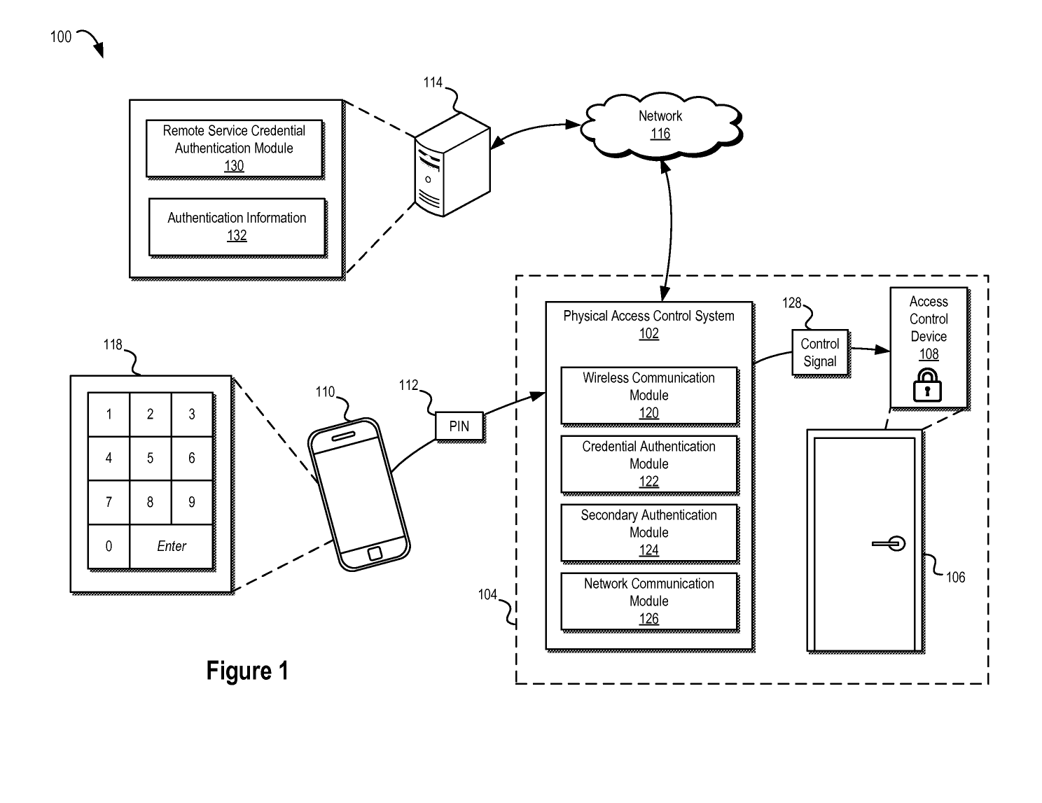

FIG. 1 illustrates an exemplary physical access control authentication architecture 100 consistent with embodiments disclosed herein. In certain embodiments, a physical access control system 102 may be associated with a distributed site 104 of an electric power generation and delivery system. In some embodiments, the physical access control system 102 may be included in a weather and/or tamper resistant and/or hardened housing. As discussed in more detail below, in some embodiments, the physical access control system 102 may utilize a mobile device 110 as an input device. In certain embodiments, utilizing a mobile device 110 as an input device may allow for service and other personnel to provide authentication credentials 112 to the physical access control system 102 without the need to utilize an static and/or otherwise integrated input device associated with the access control system 102 (e.g., integrated input devices such as touchscreens and/or keypads that may be prone to damage and/or failure due to exposure to environmental conditions).

The distributed site 104 may include a variety of equipment associated with the electric power generation and delivery system including, without limitation, one or more IEDs, network communication equipment, electrical generators, electrical motors, power transformers, power transmission and distribution lines, circuit breakers, switches, buses, transmission and/or feeder lines, voltage regulators, capacitor banks, and/or the like. In certain embodiments, the distributed site 104 may comprise a subset of equipment associated with a distributed location of an electric power generation and/or delivery system (e.g., a portion of a distribution substation). For example, in some embodiments, the distributed site 104 may comprise a distribution substation of an electric power delivery system. In further embodiments, the distributed site 104 may comprise a panel and/or utility box housing equipment associated with an electrical generation and/or delivery system.

Physical access to the distributed site 104 and/or equipment associated with the same may be via one or more access points 106. As illustrated, the access point 106 may comprise a door to a building associated with the distributed site 104. In further embodiments, the access point 106 may include one or more panels and/or boxes facilitating access to equipment housed therein. In yet further embodiments, the access point 106 may be associated with a particular piece of equipment (e.g., an IED or the like) within the distributed site 104. For example, the access point 106 may comprise an access panel to a particular piece of equipment within the distributed site 104.

Physical access by personnel using the one more access points 106 may be managed by one or more access control devices 108 associated with an access point 106. In certain embodiments, an access control device 108 may be controlled by the physical access control system 102 associated with the distributed site 104. The access control devices 108 may comprise one or more locks (e.g., electromagnetic, mechanical, and/or solenoid locks), alarm systems, and/or the like. For example, in certain embodiments, an access control device 108 may comprise an electronically actuated lock for a door.

Consistent with embodiments disclosed herein, a user may interface with the physical access control system 102 using a mobile device 110. For example, a user may provide the physical access control system 102 with authentication credentials 112 such as a personal identification number (“PIN”) or the like. Using the authentication credentials 112, the physical access control system 102 and/or a remote authentication service 114 in communication with the physical access control system 102 may authenticate access to the distributed site 104.

The physical access control system 102, the mobile device 110, the authentication service 114 and/or other associated systems may comprise any suitable computing system or combination of systems configured to implement embodiments of the systems and methods disclosed herein. In certain embodiments, the physical access control system 102, the mobile device 110, and/or the authentication service 114, and/or other associated systems may comprise at least one processor system configured to execute instructions stored on an associated non-transitory computer-readable storage medium. In some embodiments, the physical access control system 102, the mobile device 110, the authentication service 114 and/or other associated systems may further comprise secure execution space configured to perform sensitive operations such as authentication credential validation and/or other aspects of the systems and methods disclosed herein. The physical access control system 102, the mobile device 110, the authentication service 114 and/or other associated systems may further comprise software and/or hardware configured to enable electronic communication of information between the systems 102, 110, 114 via one or more associated network connections (e.g., network 116).

The physical access control system 102, the mobile device 110, and/or the authentication service 114 may comprise a computing device executing one or more applications configured to implement embodiments of the systems and methods disclosed herein. In certain embodiments, the physical access control system 102, the mobile device 110, and/or the authentication service 114 may comprise a laptop computer system, a desktop computer system, a smartphone (e.g., the Apple® iPhone™, the Motorola® Droid®, and the BlackBerry® Storm™), a tablet computer (e.g., the Apple® iPad™, the HP® Slate, and the Samsung® Galaxy™ Tablet), a server computer system and/or any other computing system and/or device that may be utilized in connection with the disclosed systems and methods.

The various systems 102, 110, 114 may communicate via one or more networks comprising any suitable number of networks and/or network connections. For example, as illustrated, the physical access control system 102 may communicate with the authentication service 114 via network 116. The network connections may comprise a variety of network communication devices and/or channels and may utilize any suitable communication protocols and/or standards facilitating communication between the connected devices and systems. The network connections may comprise the Internet, a local area network, a virtual private network, and/or any other communication network utilizing one or more electronic communication technologies and/or standards (e.g., Ethernet or the like). In some embodiments, the network connections may comprise a wireless carrier system such as a personal communications system (“PCS”), and/or any other suitable communication system incorporating any suitable communication standards and/or protocols. In further embodiments, the network connections may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network connections may incorporate one or more satellite communication links. In yet further embodiments, the network connections may utilize IEEE's 802.11 standards, Bluetooth®, ultra-wide band (“UWB”), Zigbee®, and/or any other suitable communication protocol(s).

Personnel wishing to access the distributed site 104 and/or equipment associated with the same via access point 106 may have a mobile device 110 provisioned with an authentication application. The authentication application may be configured to allow the mobile device 110 to interact with the physical access control system 102 via an authentication interface 118 associated with the authentication application. In some embodiments, the authentication interface 118 may be displayed via an interface of web-browser application of the mobile device 110 and/or any other suitable application.

Using the interface 118 of the mobile device, personnel may enter authentication credentials 112 for authenticating their rights to access the distributed site 104. In certain embodiments, the interface 118 may comprise a touchscreen, a keyboard, a mouse, a track pad, and/or any other suitable interface of the mobile device 110. For example, as illustrated, the interface 118 may comprise a 10-digit key pad displayed on a touchscreen interface of the mobile device 110. The authentication credentials 112 may comprise any type of numeric (e.g., a PIN), alphanumeric, symbolic, and/or other type of authentication credentials. In further embodiments, the authentication credentials 112 may comprise a biometric sensor input, information received from a security key or card in communication with the mobile device 110 (e.g., using a near field communication (“NFC”) standard or the like), and/or the like. Although illustrated in connection with use of a PIN as authentication credentials 112 and a 10-digit key pad for interface 118, it will be appreciated that a variety of types of authentication credentials and associated interfaces may also be used in connection with the disclosed embodiments.

After receiving the authentication credentials 112 via the interface 118, the mobile device 110 may communicate the authentication credentials 112 to the physical access control system 102. The physical access control system 102 may comprise a wireless communication module 120 comprising software and/or hardware configured to facilitate wireless communication between the physical access control system 102 and the mobile device 110. For example, in some embodiments, the physical access control system 102 may be configured to communicate with the mobile device 110 via a Bluetooth® wireless communication channel. In further embodiments, the physical access control system 102 may alternatively and/or in addition communicate with the mobile device 110 via one or more wired communication protocols (e.g., via an environmentally-hardened communication port or the like).

The physical access control system 102 may authenticate the validity of the authentication credentials 112 using a credential authentication module 122. The credential authentication module 122 may comprise software and/or hardware configured to authenticate the validity of the authentication credentials 112 provided to the physical access control system 102 and issue one or more responses and/or control signals 128 in connection with the same. For example, in certain embodiments, the credential authentication module 122 may compare a PIN included in the authentication credentials 112 with known PINs associated with personnel having current access rights to the distributed site 104.

If the PIN included in the authentication credentials 112 is a known PIN associated with personnel having current access rights to the distributed site 104, the physical access control system 102 may issue a control signal 128 to an access control device 108 associated with an access point 106 of the distributed site 104. For example, in certain embodiments, the control signal 128 may actuate a lock associated with the access point 106, may disable an alarm system associated with the access point 106, and/or the like. In further embodiments, a response indicating a successful authentication of the authentication credentials 112 may be communicated from the physical access control system 102 to the mobile device 110 and/or a remote authentication service 114.

In some embodiments, certain aspects of a credential authentication process may involve a remote authentication service 114 communicatively coupled to the physical access control system 102 (e.g., via a network communication module 126 and/or network 116). For example, in some embodiments, the physical access control system 102 may communicate authentication credentials 112 provided by the mobile device 110 to the remote authentication service 114. A remote service credential authentication module 130 may make an authentication decision based on the authentication credentials 112 and/or other authentication information 132 managed by the authentication service 114 (e.g., known PINs associated with personnel having access rights). For example, the authentication service 114 may compare a PIN included in the authentication credentials 112 with known PINs associated with personnel having current access rights to the distributed site 104. Based on the results of the determination, the authentication service 114 may communicate a response to the physical access control system 102 indicating whether the authentication credentials 112 provided by the mobile device 110 were authenticated by the service 114.

In certain embodiments, the physical access control system 102 may implement multi-factor authentication processes (e.g., a two-factor authentication process) in connection with managing physical access to the distributed site 104. Accordingly, in some embodiments, the physical access control system 102 may include a secondary authentication module 124 facilitating a second factor authentication process for managing access to the distributed site 104. In certain embodiments, authentication processes, including primary and secondary authentication processes, consistent with embodiments disclosed herein may include, without limitation, knowledge factor authentication (e.g., demonstrating knowledge of a password, a passphrase, a PIN, a challenge response, a pattern, etc.), ownership or possession factor authentication (e.g., demonstrating possession of a security and/or an identification card, a security token, a hardware token, a software token, a security key, etc.), and/or inherence and/or biometric factor authentication (e.g., providing fingerprint, retinal, signature, voice, facial recognition, and/or other biometric identifiers), and/or the like.

In at least one example of a multi-factor authentication process implementing embodiments disclosed herein, a user may provide a first factor authentication credential comprising such as, for example, a knowledge-based authentication credential (e.g., a PIN), to a physical access control system 102 via a mobile device 110 as authentication credentials 112. A second factor authentication credential (not shown) such as, for example, a possession-based authentication credential (e.g., identification information from a proximate secure card or key, a software and/or hardware token associated with the mobile device 110, etc.) may be further accessed by and/or otherwise provided to the physical access control system 102. Based on the first and second authentication credentials, the physical access control system 102 and/or the remote service credential authentication module 130 may make an authentication decision. For example, a PIN associated with the first factor authentication credential and user identification information read from a secure card associated with the second factor authentication credential may be compared with certain known credential information to, among other things, determine whether the user identification information is associated with a user having current access rights, determine whether the PIN is associated with the user, the secure card, and/or the user identification information, and/or the like, and make an authentication and/or access control decision based on the same.

It will be appreciated that a number of variations can be made to the architecture and relationships presented in connection with FIG. 1 within the scope of the inventive body of work. For example, without limitation, in some embodiments, some or all of the functions performed by the physical access control system 102 may be performed by the mobile device 110 and/or the remote authentication service 114. Similarly, some or all of the functions performed by the remote authentication service 114 may be performed by the physical access control system 102 and/or the mobile device 110. Thus it will be appreciated that the architecture and relationships illustrated in FIG. 1 are provided for purposes of illustration and explanation, and not limitation.

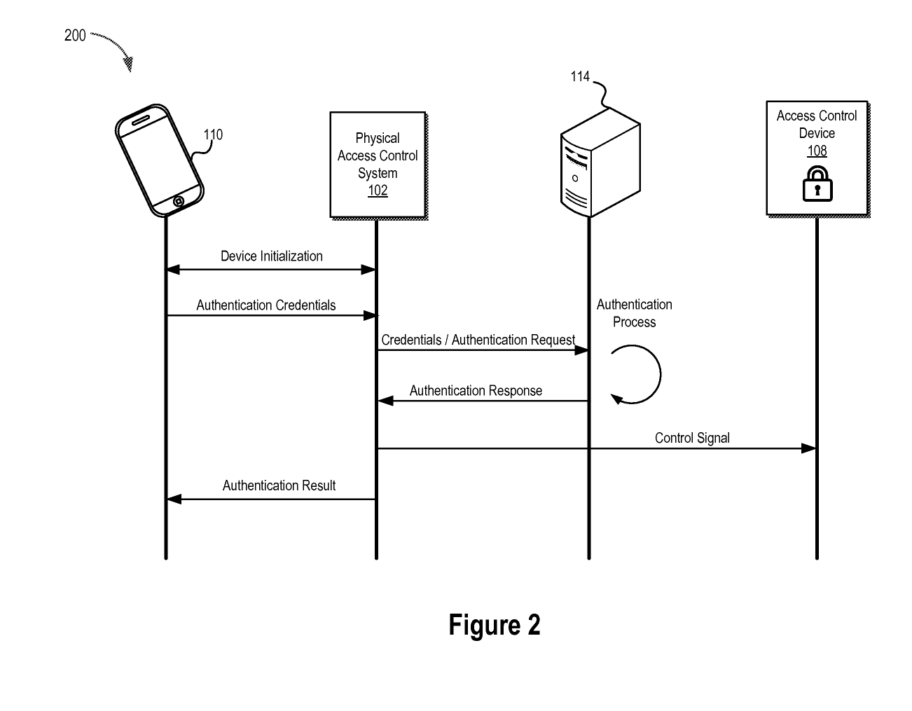

FIG. 2 illustrates a diagram 200 showing an access control authentication process consistent with embodiments disclosed herein. The access control authentication process may be used to manage and/or authenticate physical access to a distributed site of an electric power generation and/or delivery system. As discussed above, a mobile device 110, a physical access control system 102 associated with the distributed site, a remote authentication service 114, and/or an access control device 108 may be utilized in connection with embodiments of the disclosed systems and methods for authenticating physical access to a distributed site.

As illustrated, a mobile device 110 may engage in an initialization process with a physical access control system 102 associated with a distributed site. In certain embodiments, the initialization process may comprise identifying that the mobile device 110 is physically proximate to and/or physically located within a certain range of the physical access control system 102. For example, in some embodiments, the physical access control system 102 may be capable of communicating with the mobile device 110 using a wireless communication channel having a certain range extending from a location of the physical access control system 102. Accordingly, if the mobile device 110 is capable of communicating the physical access control system 102 via the wireless communication channel, it may be determined that the device 110 is within a certain distance of the physical access control system 102. Alternatively, if the mobile device 110 is not capable of communicating with the physical access control system 102 via the wireless communication channel, it may be determined that the device 110 is not within a certain distance of the physical access control system 102.

In certain embodiments, the device initialization process may comprise a polling and/or pairing process performed by the mobile device 110 and/or the physical access control system 102 (e.g., a Bluetooth® pairing process or the like). For example, the physical access control system 102 may periodically perform a polling process to identify mobile devices 110 proximate to the physical access control system 102 and/or initiate a pairing process with such devices 110. In certain embodiments, the device initialization process may initialize when an authentication application executing on the mobile device 110 is opened. In some embodiments, the device initialization process may, at least in part, establish a secure communication channel between the mobile device 110 and the physical access control system 102 allowing secure communication of authentication credentials and/or other information therebetween.

After initializing, authentication credentials (e.g., a PIN or the like) input to the mobile device 110 may be communicated from the mobile device 110 to the local physical access control system 102. The physical access control system 102 may transmit the authentication credentials along with an authentication request to a remote authentication service 114. Upon receipt of the request and/or the associated authentication credentials, the authentication service 114 may perform an authentication process based on the authentication credentials and/or the authentication request. For example, the authentication service 114 may compare a PIN included in the authentication credentials with known PINs associated with personnel having current access rights to the distributed site associated with the physical access control system 102. Based on the results of the determination, the authentication service 114 may communicate an authentication response to the physical access control system 102 indicating whether the authentication credentials provided by the mobile device 110 were authenticated by the authentication service 114. In some embodiments, certain processes illustrated in connection with FIG. 2 as being performed by a remote authentication service 114 may be performed locally at a distributed site by the physical access control system 102.

If authentication credentials input to the mobile device 110 are authenticated by the authentication service 114, the physical access control system 102 may issue a control signal to an access control device 108 associated with an access point of the distributed site. For example, in certain embodiments, based on the contents of the authentication response returned by the authentication service 114, the physical access control system 102 may generate a control signal configured to actuate a lock associated with the access point, to disable an alarm system associated with the access point, and/or the like. In further embodiments, a response indicating an authentication result (e.g., “Access Granted” or “Access Denied”) may be communicated from the physical access control system 102 to the mobile device 110 and displayed to a user of the mobile device 110.

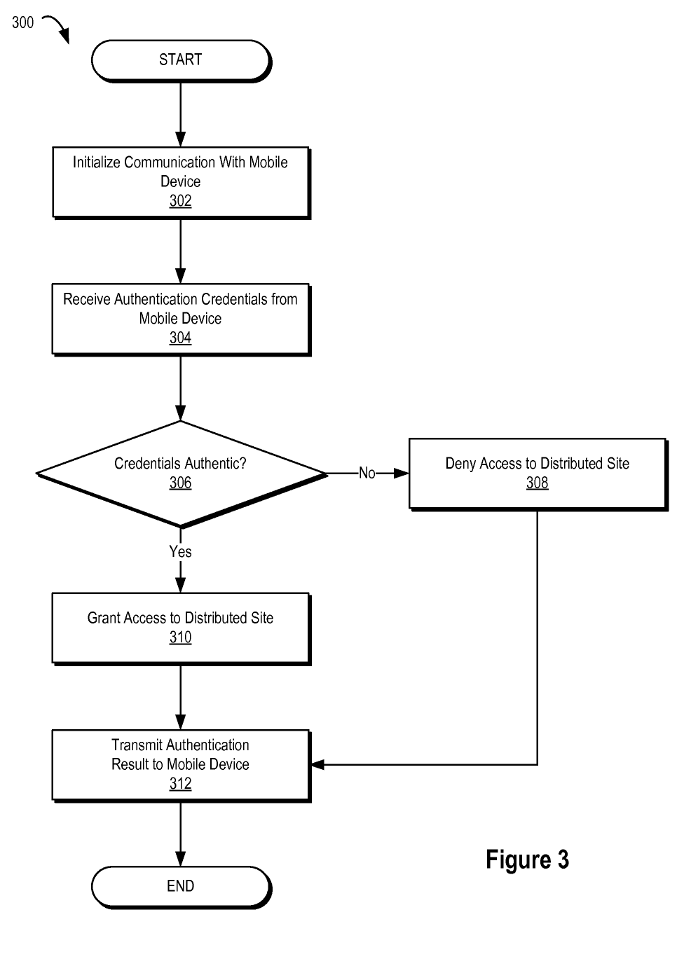

FIG. 3 illustrates a flow chart of a method 300 for authenticating physical access to a distributed site of an electric power generation and/or delivery system consistent with embodiments disclosed herein. In certain embodiments, elements of the method 300 may be performed by a physical access control system associated with a distributed site of an electric power generation and/or delivery system. In further embodiments, elements of the method 300 may be performed by a remote authentication system and/or a mobile device.

At 302, communication with a mobile device may be initialized. In certain embodiments, this initialization process may comprise a pairing process between a mobile device and/or a proximately located physical access control system. In some embodiments, the initialization process may be performed as a result of a proximately located mobile device being identified as part of a polling process performed by a physical access control system. In further embodiments, the device initialization process may, at least in part, establish a secure communication channel between the mobile device and the physical access control system, thereby allowing for secure communication of information exchanged therebetween.

Authentication credentials may be received from the mobile device at 304. As discussed above, in certain embodiments, the authentication credentials may comprise a PIN, although any other type of authentication credentials may be utilized in connection with embodiments of the disclosed systems and methods. At 306, a determination may be made as to whether the credentials received from the mobile device at 304 are authentic. That is, a determination may be made as to whether the authentication credentials are associated with an individual having current access rights to an associated distributed site. In certain embodiments, the determination may comprise comparing the received authentication credentials with one or more known access credentials associated with individuals having current access rights to the distributed site. If the received authentication credentials match with one or more known access credentials, the credentials may be determined to be authentic. Otherwise, the credentials may be determined to be not authentic.

If the authentication credentials are determined to be not authentic, the method 300 may proceed to 308, where access to a distributed site may be denied to the personnel requesting access. A result of the negative authentication determination performed at 306 may be transmitted to the mobile device at 312 (e.g., “Access Denied” or the like). In some embodiments, one or more responsive and/or protective actions may further be implemented to protect the distributed site from potential unauthorized access. If, however, the authentication credentials are determined to be authentic, the method 300 may proceed to 310.

At 310, access to the distributed site may be granted. For example, in some embodiments, the physical access control system may issue one or more control signals to associated access control devices configured to allow an individual physical access to the distributed site and/or associated equipment (e.g., by issuing a control signal configured to disengage a solenoid lock, disable an alarm system, and/or the like). A result of the positive authentication determination performed at 306 may be further transmitted to the mobile device at 312 (e.g., “Access Granted” or the like).

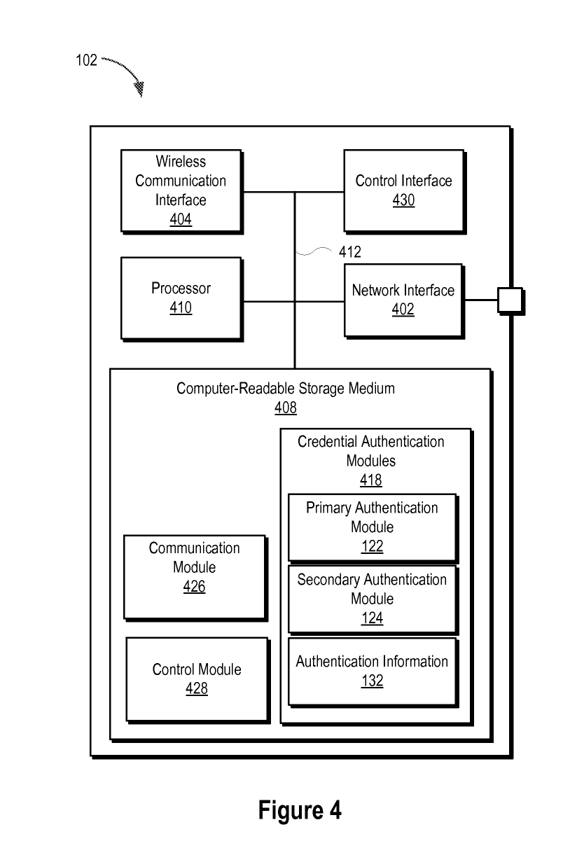

FIG. 4 illustrates a functional block diagram of a physical access control system 102 consistent with embodiments disclosed herein. Embodiments of the IED physical access control system 102 may be utilized to implement embodiments of the systems and methods disclosed herein. For example, the physical access control system 102 may be configured to interface with a mobile device associated with an individual requesting access to a distributed site of an electric power generation and delivery system and/or manage access to the distributed site based on authentication credentials provided to the physical access control system 102 using the mobile device.

The physical access control system 102 may include a network interface 402 configured to communicate with a communication network. The physical access control system 102 may further include a wireless communication interface 404 configured to facilitate communication with a network, other systems and/or devices, and/or mobile devices. For example, in some embodiments, the physical access control system 102 may be configured to securely communicate with a proximately located mobile device and/or receive authentication credentials from the mobile device using the wireless communication interface 404.

A computer-readable storage medium 408 may be the repository of one or more modules and/or executable instructions configured to implement any of the processes described herein. A data bus 412 may link the network interface 402, the wireless communication interface 404, and the computer-readable storage medium 408 to a processor 410. The processor 410 may be configured to process communications received via network interface 402 and/or wireless communication interface 404. The processor 410 may operate using any number of processing rates and architectures. The processor 410 may be configured to perform various algorithms and calculations described herein using computer executable instructions stored on computer-readable storage medium 408.

The computer-readable storage medium 408 may be the repository of one or more modules and/or executable instructions configured to implement certain functions and/or methods described herein. For example, computer-readable storage medium 408 may include one or more credential authentication modules 418, which may be a repository of the modules and/or executable instructions configured to implement the credential authentication and/or access control functionalities described herein. The credential authentication modules 418 may include, among other things, a primary authentication module 122, a secondary authentication module 124, and/or authentication information 132. The computer-readable medium 408 may further include a communication module 426 and a control module 428.

The primary authentication module 122 may perform a first factor authentication process consistent with embodiments disclosed herein. For example, as discussed above, in certain embodiments, the primary authentication module 122 may implement a knowledge factor-based authentication process (e.g., a PIN authentication process) in connection with authenticating physical access to a distributed site. The secondary authentication module 124 may perform a second factor authentication process for authenticating access to the distributed site. In certain embodiments, the primary authentication module 122 and/or the secondary authentication module 124 may utilize authentication information 132 (e.g., known authentication credentials associated with individuals having current access rights) managed by the physical access control system 102 and/or an associated remote system in connection with authentication determination processes.

A control module 428 may be configured to interact with access control devices associated with the physical access control system 102 via control interface 430. According to some embodiments, control instructions issued by the control module 428 via control interface 430 may be configured to allow and/or deny access to a distributed site and/or equipment associated with the same. In certain embodiments, the control interface 430, the wireless communication interface 404, and/or the network interface 402 may be included in a single communication interface and/or any combination of interfaces.

In some cases, control instructions may be only informative or suggestive, meaning that the receiving device is not obligated to perform the control instruction. Rather, the receiving device may use the suggested control instruction in coordination with its own determinations and information from other controllers to determine whether it will perform the control instruction. In other cases control instructions may be directive in that they are required actions. Differentiation between informative or suggestive control instructions and mandatory control instructions may be based on information included with the control instructions.

A communication module 426 may include instructions for facilitating communication of information from physical access control systems to other controllers, systems, devices, and/or other components in the electric power delivery system and/or a distributed site associated with the same. The communication module 426 may include instructions on the formatting of communications according to a predetermined protocol. Communication module 426 may be configured with subscribers to certain information, and may format message headers according to such subscription information.

While specific embodiments and applications of the disclosure have been illustrated and described, it is to be understood that the disclosure is not limited to the precise configurations and components disclosed herein. For example, the systems and methods described herein may be applied to a variety of distributed sites of an electric power generation and delivery system. It will further be appreciated that embodiments of the disclosed systems and methods may be utilized in connection with a variety of systems, devices, and/or applications utilizing physical access control systems and methods, and/or applications that are not associated with and/or are otherwise included in an electric power delivery system. Accordingly, many changes may be made to the details of the above-described embodiments without departing from the underlying principles of this disclosure. The scope of the present invention should, therefore, be determined only by the following claims.

What is claimed is:

1. A physical access control system associated with distributed site of an electric power delivery system, the system comprising:
a wireless communication interface configured to receive authentication credentials from a mobile device proximately located to the physical access control system;
a control interface communicatively coupled to an access control device associated with the distributed site;
a processor communicatively coupled to the wireless communication interface and the control interface;
a computer-readable storage medium communicatively coupled to the processor, the computer-readable storage medium storing instructions that when executed by the processor cause the processor to:
determine whether the authentication credentials received by the wireless communication interface are associated with an individual having current access rights to the distributed site;
generate, based on the determination, a control signal configured to implement an access control action by the access control device associated with the distributed site; and
transmit, using the control interface, the control signal to the access control device associated with the distributed site.

2. The system of claim 1, wherein the mobile device comprises at least one of a smartphone device, a tablet computing device, and a laptop computing device.

3. The system of claim 1, wherein the wireless communication interface comprises a wireless communication interface and the instructions are further configured to cause the processor to:
establish a secure communication channel between the mobile device and the physical access control system.

4. The system of claim 1, wherein the distributed site comprises at least one of a substation location, a utility box, and an equipment enclosure of the electric power delivery system.

5. The system of claim 1, wherein the access control device comprises at least one of a mechanical lock, an electromagnetic lock, a solenoid lock, and an alarm system.

6. The system of claim 1, wherein the control signal is configured to cause the access control device to actuate a lock associated with the distributed site.

7. The system of claim 1, wherein the control signal is configured to cause the access control device to change a status of an alarm system associated with the distributed site.

8. The system of claim 1, wherein the system further comprises a weather-resistant enclosure configured to protect elements of the system from environmental exposure.

9. The system of claim 1, wherein performing the determination regarding whether the authentication credentials received by the wireless communication interface are associated with an individual having current access rights to the distributed site comprises:
comparing the received authentication credentials with one or more known credentials associated with individuals having current access rights to the distributed site;
determining that the received authentication credentials match at least one of the one or more known credentials; and
determining that the received authentication credentials are authentic.

10. The system of claim 1, wherein performing the determination regarding whether the authentication credentials received by the wireless communication interface are associated with an individual having current access rights to the distributed site comprises:
comparing the received authentication credentials with one or more known credentials associated with individuals having current access rights to the distributed site;
determining that the received authentication credentials do not match at least one of the one or more known credentials; and
determining that the received authentication credentials are not authentic.

11. The system of claim 1, wherein the received authentication credentials comprise at least one of a personal identification number, a password, a passphrase, a response to a challenge, a pattern, information stored on a card, information stored on a security token, information stored on a hardware token, information stored on a software token, and biometric identification information.

12. The system of claim 1, wherein the instructions are further configured to cause the processor to:
generate, based on the determination, an authentication result; and
transmit, using the wireless communication interface, the authentication result to the mobile device.

13. A method for authenticating physical access to a distributed site of an electric power delivery system comprising:
receiving, at a wireless communication interface of a physical access control system, authentication credentials from a mobile device;
determining whether the received authentication credentials are associated with an individual having current access rights to the distributed site;
generating, based on the determination, a control signal configured to implement an access control action by an access control device communicatively coupled to the physical access control system; and
transmitting, via a control interface of the physical access control system, the control signal to the access control device associated with the distributed device.

14. The method of claim 13, wherein the mobile device comprises at least one of a smartphone device, a tablet computing device, and a laptop computing device.

15. The method of claim 13, wherein the wireless communication interface comprises a wireless communication interface and the method further comprises establishing a secure communication channel between the mobile device and the physical access control system.

16. The method of claim 13, wherein the distributed site comprises at least one of a substation location, a utility box, and an equipment enclosure of the electric power delivery system.

17. The method of claim 13, wherein the control signal is configured to cause the access control device to actuate a lock associated with the distributed site.

18. The method of claim 13, wherein the control signal is configured to cause the access control device to change a status of an alarm system associated with the distributed site.

19. The method of claim 13, wherein determining whether the received authentication credentials are associated with an individual having current access rights to the distributed site comprises:
comparing the received authentication credentials with one or more known credentials associated with individuals having current access rights to the distributed site;
determining that the received authentication credentials match at least one of the one or more known credentials; and
determining that the received authentication credentials are authentic.

20. The method of claim 13, wherein determining whether the received authentication credentials are associated with an individual having current access rights to the distributed site comprises:
comparing the received authentication credentials with one or more known credentials associated with individuals having current access rights to the distributed site;
determining that the received authentication credentials do not match at least one of the one or more known credentials; and
determining that the received authentication credentials are not authentic.

21. The system of claim 13, wherein the received authentication credentials comprise at least one of a personal identification number, a password, a passphrase, a response to a challenge, a pattern, information stored on a card, information stored on a security token, information stored on a hardware token, information stored on a software token, and biometric identification information.

22. A physical access control system comprising:
a wireless communication interface configured to receive a first factor authentication credential and a second factor authentication credential from a mobile device proximately located to the physical access control system;
a control interface communicatively coupled to an access control device associated with the distributed site;
a processor communicatively coupled to the wireless communication interface and the control interface;
a computer-readable storage medium communicatively coupled to the processor, the computer-readable storage medium storing instructions that when executed by the processor cause the processor to:
determine whether the first and second factor authentication credentials received by the wireless communication interface are associated with an individual having current access rights to the distributed site;
generate, based on the determination, a control signal configured to implement an access control action allowing access to the distributed site by the access control device associated with the distributed site; and
transmit, using the control interface, the control signal to the access control device associated with the distributed site; and
an enclosure configured to retain and protect the wireless communication interface, the control interface, the processor, and the computer-readable storage medium from environmental conditions.
